(19) United States
(12) Patent Application Publication
(10) Pub. No.: US 2017/0167086 A1
(43) Pub. Date: Jun. 15, 2017

(54) PERMEABLE SURFACE COVERING UNITS AND PERMEABLE SURFACE COVERING

(71) Applicant: Keystone Retaining Wall Systems LLC, Minneapolis, MN (US)

(72) Inventors: Robert A. MacDonald, Plymouth, MN (US); Thomas S. Riccobene, Albuquerque, NM (US)

(21) Appl. No.: 15/443,105

(22) Filed: Feb. 27, 2017

Related U.S. Application Data
(62) Division of application No. 14/105,679, filed on Dec. 13, 2013.
(60) Provisional application No. 61/737,452, filed on Dec. 14, 2012.

(51) Int. Cl. E01C 11/22; B28B 7/28; B28B 7/20; E01C 5/00; B28B 7/18

(52) U.S. Cl. CPC E01C 11/225; E01C 5/006; E01C 5/00; B28B 7/183; B28B 7/20; B28B 7/285; E01C 2201/02; E01C 2201/207; E01C 5/06

(57) ABSTRACT

A permeable surface covering unit comprises a top surface, a bottom surface and at least two pairs of sides. A cavity is formed in the unit from the top surface to the bottom surface, and has side walls. The cavity may be a side cavity between units and/or a core cavity within the unit. An undercut is provided in the cavity. Pervious material plugs fill the cavity and extend into the undercut. Thereby the plug is locked into the cavity like a rivet and resists being dislodged by mechanical or hydraulic forces.

### PRIORITY CLAIM

This application is a divisional application of U.S. Ser. No. 14/105,679 filed on Dec. 13, 2013, which claims priority of U.S. Provisional Application Serial No. 61/737,452, filed Dec. 14, 2012.

### FIELD OF THE INVENTION

The subject disclosure relates to permeable and pervious pavers, patio stones, and other building unit blocks for covering a surface that permit a movement of liquid, such as rain water, through and/or around the blocks of the surface.

### BACKGROUND OF THE INVENTION

It is well known to construct permeable or pervious surface coverings to provide a solid ground surface and yet allow water to filter through the surface covering into the ground or into a sub-base water storage, retention, or drainage system. Pervious surface coverings and structures are conventionally constructed of manufactured pavers, bricks or other similar units. Manufactured units are typically provided in various geometric shapes, such as squares and rectangles. Surfaces covered with the manufactured units typically are laid in repeating and easily recognizable patterns. Some pervious surfaces coverings, such as parking lots and the like are required to withstand mechanical forces from vehicular traffic and snow plows, and/or hydraulic forces such as water pressure. Conventional permeable surface coverings have achieved varying degrees of success in terms of water retention capacity, structural integrity, durability and aesthetic appeal.

### SUMMARY OF THE INVENTION

An embodiment of the invention provides a permeable surface covering unit that comprises a top surface, at least two pairs of irregularly shaped mating sides, at least one channel for retaining liquid, and at least one passageway for conveying liquid from the unit top surface to the channel The channel is preferably located on the bottom of the unit. The passageway in one embodiment is defined between spacers on the sides of the unit. The sides of the unit preferably define a rotational tessellation element, but other forms of tessellations, including glides and combination glides and rotations can be used.

In another embodiment of the invention, a permeable surface covering unit comprises a top surface, a bottom surface and at least two pairs of sides. The unit includes at least one core cavity having side walls and extending from the unit top surface to the unit bottom surface. At least one channel is provided in the bottom of the unit or alternatively an undercut is formed in at least one of the side walls of the cavity. A pervious material plug is cast into and at least partially fills the cavity and slumps into the channel or undercut. Thereby the plug is locked into the cavity like a rivet, and thereby resists being dislodged by mechanical or hydraulic forces.

A permeable surface covering embodiment is provided comprising a plurality of units, each unit having top surface and at least two pairs of irregularly shaped sides. The irregularly shaped sides of adjacent units in the surface covering engage and interlock with each other. At least a portion of the units have at least one cavity, preferably plural side cavities. The side cavities of adjacent units in the surface covering align to form larger cavities. Pervious material plugs are secured within at least a portion of the cavities in the surface covering. In a preferred surface covering embodiment, at least a portion of the units include a bottom channel extending from side to side of the unit and intersecting with the side cavities. In a more preferred embodiment the bottom channels in a plurality of adjacent units align with one another such that liquid can be conveyed through the aligned channels below the surface to a cistern, storm drain or other sub-surface water storage/conveyance system. Optionally, the side channels can include locking slots, and stakes or rods may be driven through the slots to laterally secure the units in position.

The embodiments of the invention provide an improved permeable surface covering units and permeable surface covering systems achieving one or more of the objects of enhanced water retention capacity, structural integrity, durability and aesthetic appeal. The foregoing and other aspects and features of the disclosure will become apparent to those of reasonable skill in the art from the following detailed description, as considered in conjunction with the accompanying drawings.

### BRIEF DESCRIPTION OF THE DRAWINGS

FIG. 1A is a perspective view of a first embodiment of a permeable surface covering unit.

FIG. 1B is a top plan view thereof.

FIG. 2A is a side view thereof.

FIG. 2B is side view of showing an alternate channel configuration.

FIG. 3A is a plan view of a partial permeable surface covering of the first embodiment.

FIG. 3B shows a mold box for manufacturing units of the first embodiment.

FIG. 4A is a plan view of an alternate version of a permeable surface covering of the first embodiment.

FIG. 4B shows a mold box for manufacturing units shown in FIG. 4A.

FIG. 5A is a plan view of a partial permeable surface covering of the second embodiment.

FIG. 5B shows a mold box for manufacturing units shown in FIG. 5A.

FIG. 6 is a partial cross-section taken along line 6-6 of FIG. 5A.

FIG. 7 is a plan view of a permeable surface covering of a third embodiment.

FIG. 8 is a partial cross-section taken along line 8-8 of FIG. 7.

FIG. 9 is a plan view of a permeable surface covering of a fourth embodiment.

FIG. 10 is an exploded partial perspective view of a locking slot of the fourth embodiment.

FIG. 11 is a partial cross-section taken along line 11-11 of FIG. 9.

FIG. 12 is a perspective view of a fifth embodiment of a permeable surface covering unit.

FIG. 13 is a cross-section taken along line 13-13 of FIG. 12.

FIG. 14 is a perspective view of an alternate version of the fifth embodiment of a permeable surface covering unit showing the unit without a pervious plug.

FIG. 15 is a cross-section of the unit of FIG. 14 but with the pervious plug in place.

FIG. 16 is a surface covering of the fifth embodiment.

FIG. 17A is a perspective view of a sixth embodiment of a permeable surface covering unit.

FIG. 17B is a surface covering of the sixth embodiment.

FIG. 18 is a perspective view of a seventh embodiment of a permeable surface covering unit.

FIG. 19 is a cross-section taken along line 19-19 of FIG. 18.

FIG. 20 is a cross-section taken along line 20-20 of FIG. 18.

FIG. 21 is a top plan view of the seventh embodiment of a permeable surface covering unit.

FIG. 22 is a partial perspective view of an alternative, key-hole shaped locking slot.

FIG. 23 is a partial perspective view of an alternative, “T” shaped locking slot.

FIG. 24A is a perspective view of an eighth embodiment of a permeable surface covering unit without a pervious plug.

FIG. 24B is a transverse cross-sectional view of the eighth embodiment of a permeable surface covering unit with a pervious plug.

FIG. 25 is a cross-sectional view of a molding apparatus.

FIG. 26 is a detailed perspective view of a pendulum device of the molding apparatus shown in FIG. 25.

### DETAILED DESCRIPTION OF PREFERRED EMBODIMENTS

The following is a detailed description of certain embodiments of the invention presently deemed by the inventors to be the best mode of carrying out their invention. The invention as defined by the appended claims is not limited to these embodiments, and additional embodiments of the claimed inventive concept will undoubtedly be apparent to those skilled in the art.

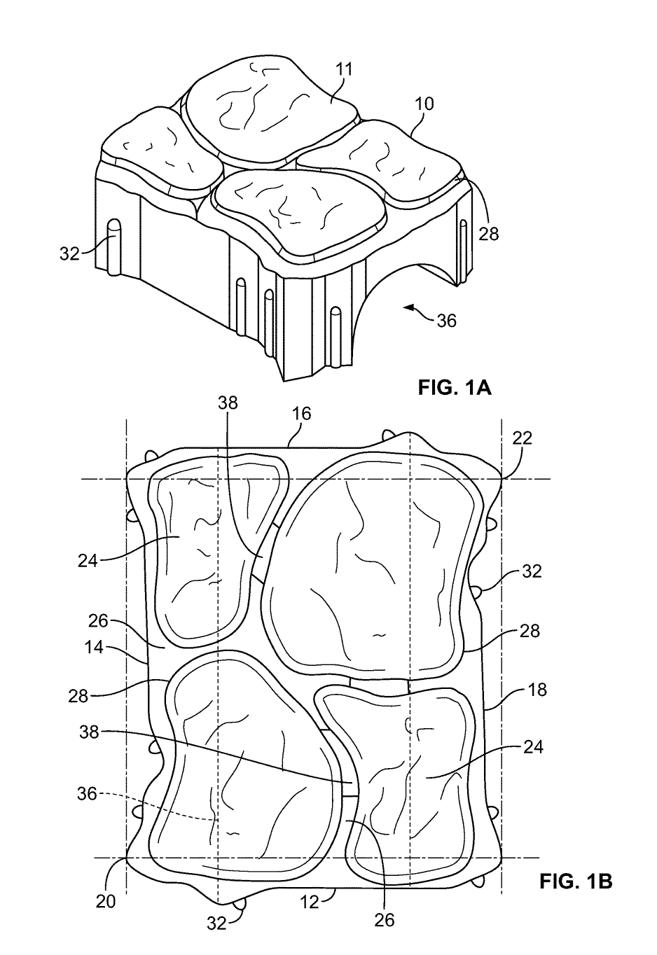

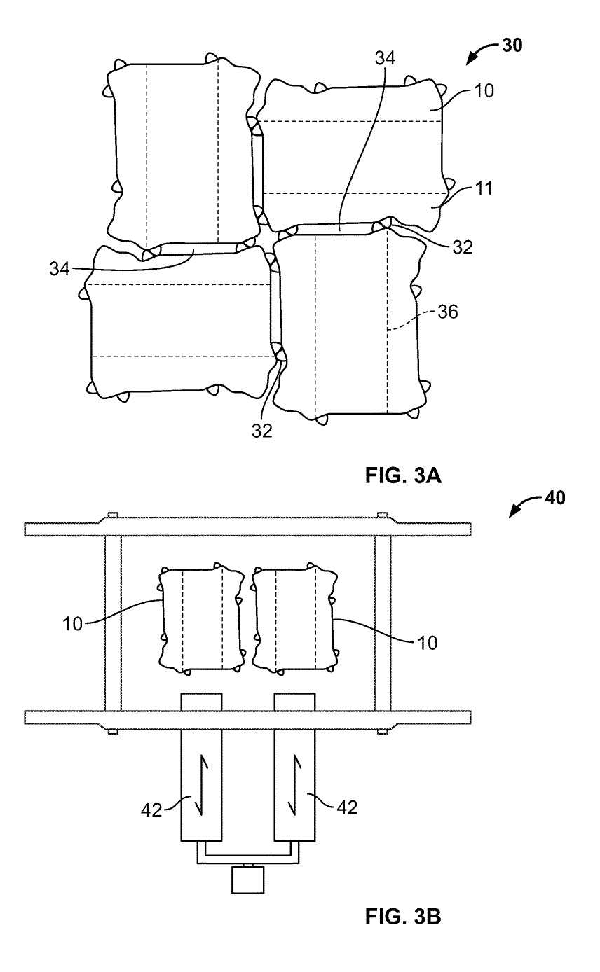

Referring now to the drawings, FIGS. 1-4 illustrate a first embodiment of a paving or surface covering unit 10 in accordance with the present disclosure. The unit can be molded of pervious, partially pervious or substantially impervious material, e.g., concrete. The exterior configuration the unit is preferably an irregular tessellation as shown and described for example in U.S. Patent Nos. D661,409 issued Jun. 5, 2012 and 7,393,155 issued Jul. 1, 2008, which are hereby incorporated by reference. Specifically, in the first embodiment, unit 10 has four sides, 12, 14, 16 and 18, all of which have the same general shape or configuration in plan view. Sides 12 and 14 are rotational images of one another, rotated 90 degrees about vertex 20. Similarly, sides 16 and 18 are rotational images of one another, rotated 90 degrees about vertex 22. Further, sides 14 and 18 can be generally viewed as concave, whereas sides 12 and 16 can be viewed as convex. The convex sides of any unit 10 will mate with any concave side of another unit 10, and vice versa, as illustrated in FIG. 3A. The irregularly shaped mating sides provide interlocking engagement for improved structural integrity to the surface and an attractive, natural appearance.

As shown in FIG. 1A, the sides and upper surface of the unit 10 may optionally be sculpted to provide for one or more stone, cobble or slab elements 24 separated by false joints 26. The number, size and configuration of the stone or cobble elements are matters of design choice and may vary from unit to unit. The edges 28 of the elements many be drawn inwardly from the unit sides 12-18, and the distance from the element edges 28 to the unit side edges may vary within a given unit as shown and from unit to unit. Similarly, the false joints 26 can vary in number, configuration, width and depth in different units. The combination of sculpted side and top surfaces, natural stone or cobble elements, false joints and irregularly shaped sides add to the natural appearance of a surface covering assembled with units 10 of the invention.

As used herein, the term “units” refers to pavers, concrete masonry units, bricks, blocks, stones or tiles that can be used in the construction of roads, driveways, walkways, parking lots, patios, revetments, floors, and other surface covering structures, including interior as well as exterior surface coverings, and including load bearing and non-load bearing structures. By the terms “irregularly shaped” and “irregular configuration” it is meant that the side appears jagged or rough hewn and lacks formal symmetry such that the side has the appearance of natural stone. Although a side comprising a single straight line or a single smooth curve is not “irregular” as that term is used herein, an irregularly shaped side can comprise a series of straight-line segments or a series of curved segments or a combination thereof, such that the overall appearance of the side is irregular. Surface coverings assembled with units having irregular sides have a natural appearance such that a regular geometric pattern is not readily apparent. Although in the preferred embodiments all sides of the units have irregular sides, one or more sides optionally can consist of or include a straight segment or a regular geometric curve. Other embodiments have regular sides as described below.

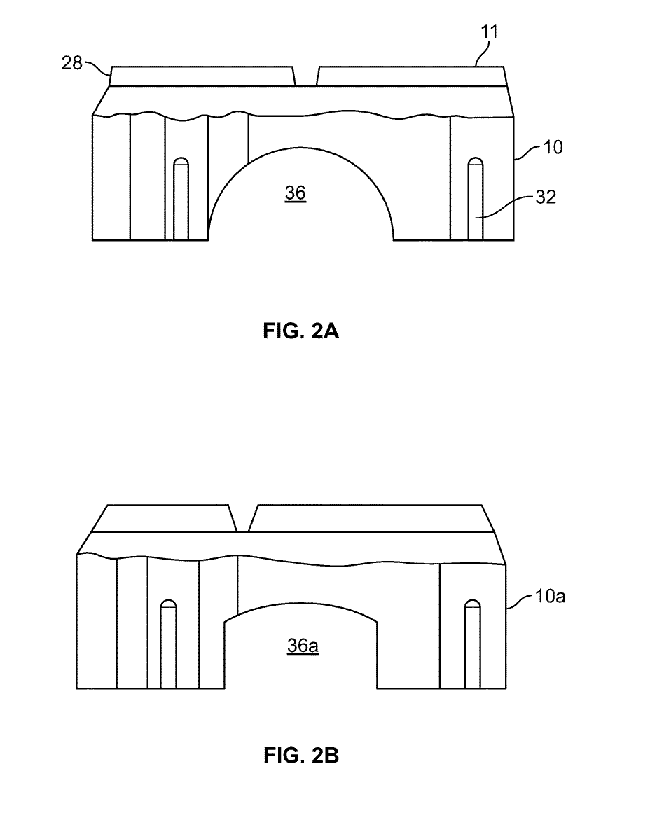

Turning now to FIG. 3A, a surface covering 30 can be constructed of multiple units 10 to collect, retain and/or convey liquids, such as storm water, snow melt, pressure washing solutions, etc. More specifically, unit 10 includes one or more spacers 32 on the sides of the unit adapted to form gaps 34 between units to convey liquid to one or more under chambers or cavities channels, 36. Water or other liquids can be retained in the under channels. Spacers 32 can be any length, height or shape. In the first embodiment, plural spacers are provided on each side, each spacer being recessed somewhat from the visible top surface 11 of the unit so they are not apparent in a finished surface covering. A single under channel 36 can be provided, as shown in FIG. 2A, but multiple channels can be provided. As used herein the terms “channel” and “under channel” refer to any channel, cavity or chamber below the top surface of the unit configured to capture, retain or covey liquid. The under channel or channels can have any desired shape such as the arch-shaped channel 36 shown in FIG. 2A. FIG. 2B shows an alternate channel having planar side walls and semi-arch top wall. Other shapes can be used, including but not limited to an omega Ω shape and irregular shapes. The channel of the first embodiment extends longitudinally from side to side of the unit. However, in other embodiments the channel may extend only to one side, or any number of sides. Although not preferred, the channel could be internal of the unit sides.

In addition to conveying liquid through gaps 34 between units, passageways 38 may be optionally provided within the unit 10. In particular, sections of the false joints 26 can extend downwardly through the unit to form a drainage passageway 38, as best shown in FIG. 1B. Passageways 38 preferably connect to under channel 36, but it not required that every passageway directly connects to a channel The passageways can be open, or can be filled with pervious materials as described herein below. False joints 26 also function to channel water to the gaps and passageways to facilitate drainage.

In one example embodiment, the general dimensions of a paver unit made in accordance with the invention are 13″×11″×5.625″ and provides 140 cubic inches of water storage capacity in channel 36. Accordingly, approximate 0.1 cubic feet of water can be retained per square foot of surface. Alternate paver embodiments can be configured to retain between 0.05 and 0.15 cubic feet of liquid storage capacity per square foot of surface area.

FIG. 3A is a top plan view of an exemplary, partial surface covering 30 comprised of multiple units 10. As shown, gaps 34 between units facilitate water drainage. The gaps can be filled with pervious material. The pervious material may include a binder, such as a polymer resin, or may be binder free, such as sand. FIG. 3B is a top plan view of an exemplary mold box 40 for manufacturing surface covering units 10 from dry cast concrete. Reciprocating core pullers 42 are used to form channels 36 in two units per cycle, as is well known in the art.

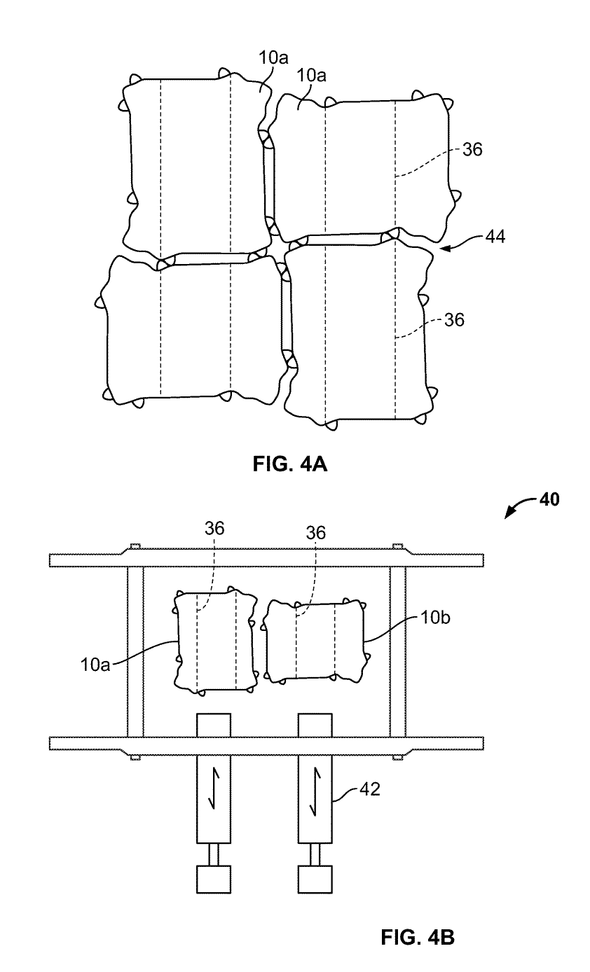

FIG. 4A illustrates an alternate surface covering embodiment 44. In one portion of the units 10a, channels 36 extend in a longitudinal direction of the unit, and in another portion of the units 10b, channels 36 extend in a transverse direction. Thereby, when assembled, channels 36 align as shown in FIG. 4A. Alignment of the channels allows water to be conveyed beneath the surface, rather than merely retaining water. The aligned channels can convey water or other liquid to a cistern, storm drain or other sub-surface water storage/conveyance system. FIG. 4B illustrates a mold box 40 and core pullers 42 configured to produce units 10a and 10b in pairs.

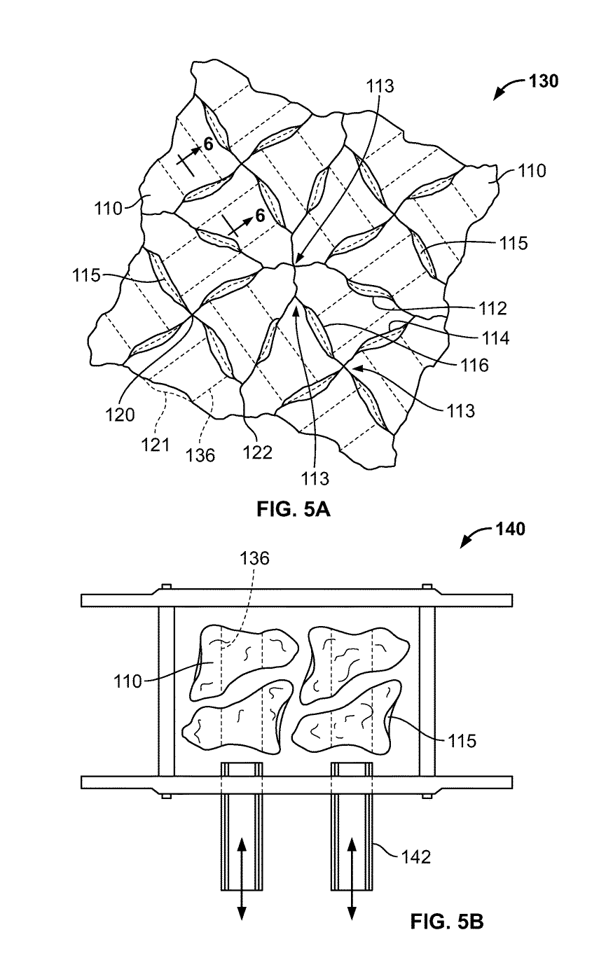

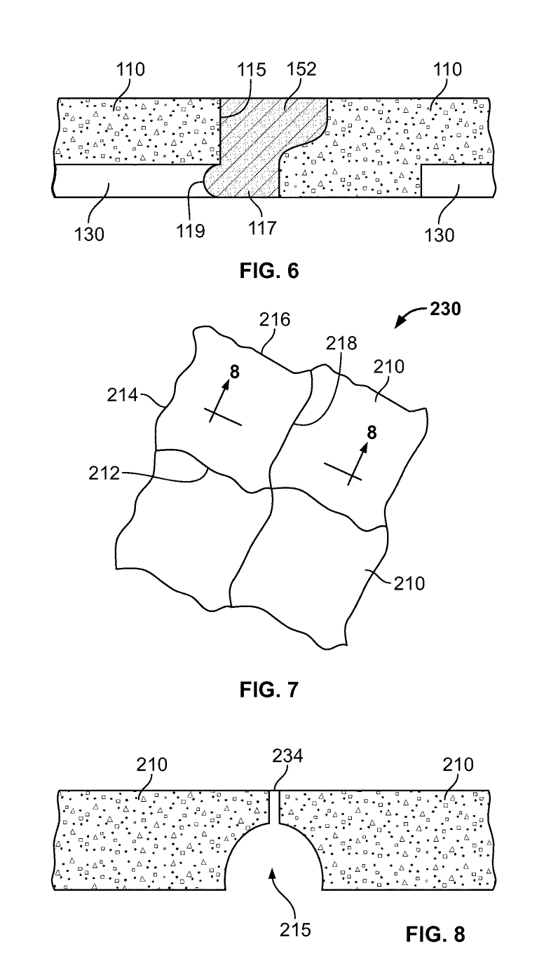

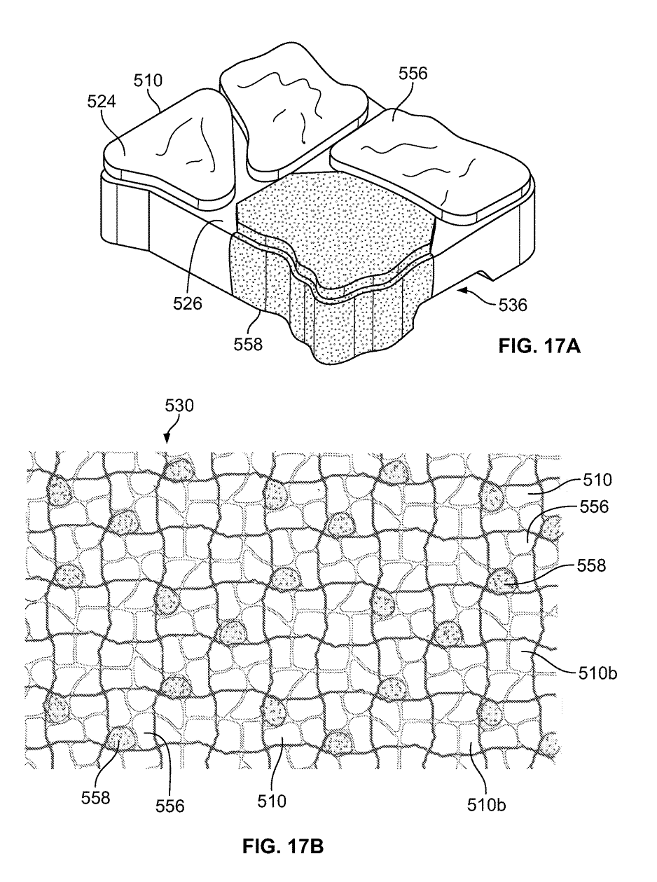

FIGS. 5A, 5B and 6 illustrate a second paver unit 110 embodiment of the invention. Unit 110 is an irregular rotational tessellation unit configured substantially in accordance with U.S. Pat. No. 7,393,155, FIG. 17 embodiment. More specifically, unit 110 has three pairs of irregular sides that extend from first 120, second 121 and third 122 vertices, respectively. The sides in each pair of sides are substantially rotational images of one another, rotated at angles 90, 180 and 90 degrees about vertices 120, 121 and 122, respectively. Each pair of sides has a different length as configuration as compared to the other pairs. Although the unit 110 has six irregular sides, it can be viewed as being generally triangular having three major or long sides 112, 114 and 116 (side 112 is actually 2 sides rotated 180 degrees about vertex 121). In surface covering 130, structural connections between units 110 are made at corners 113. At the corners, the spacing between units, especially the lower or base portion of the units is minimal or touching to provide structural integrity to the surface covering, especially if the surface is subject to torque or other forces exerted by road traffic. Intermediate the corners, side cavities or recesses 115 are provided in the major sides for liquid retention and conveyance. The side cavities can be stepped or may extend substantially vertical, i.e., without a step. The side cavities can be regularly shaped, such as an oval, but more preferably are irregularly shaped. The terms “cavity” and “side cavity” as used herein mean a recess or pocket formed into the side of the unit such that when multiple units are assembled a cavity is defined between units having an appreciable volume, substantially greater than that of a typical joint or gap between units. The area in plan view of the side cavities is in the range of 3 to 15 percent of the total area of the unit, more preferably in the range of 5 to 10 percent of the unit area. In some embodiments the side cavities are filled with pervious polymer matrix having sufficient structural strength that the area of the side cavities can be expanded to as much as 40 percent of the total unit surface area. The term “passageway” as used herein means any cavity, gap, channel or conduit by which water or other liquid may be conveyed.

The units of the first and second embodiments can be classified as an irregular, rotational tessellations as disclosed in U.S. Pat. No. 7,393,155. However, it should be understood that the present disclosure is not limited to rotational tessellations. Other tessellation forms may be advantageously employed, including glides and glide-rotation combinations.

Units 110 optionally include under cannels or cavities 136, as described above relative the first embodiment. In lieu of the under channel, the bottom edge of the unit adjacent the side channel can be provided with an undercut as described below in reference to the eighth embodiment herein below. Side cavities 115 can be filed with pervious material 117, such as sand, and preferably includes a binder, such as a polymer resin. As illustrated in FIG. 5A side cavities 115 intersect with under cavities 136, whereby liquid, e.g., storm water, conveyed via cavities 115 to the under cannels 136 to increase water retention capacity.

Surface covering 130 is constructed by first laying the units 110 on the ground or prepared subsurface. The subsurface can be substantially impermeable, but preferably is permeable. Subsequently, side cavities 115 are filled with pervious material 117, e.g., a mixture of an aggregate and a polymer resin or other binding or cementitious material. The pervious material is poured to fill the side cavities and is allowed to slump 119 into the under channel 136 (or undercut) as shown in FIG. 6. When the resin or other cementitious material cures, a pervious matrix or plug 152 is formed that is locked in under the unit 110. The combination of interlocking units having irregularly shaped sides, positive structural connection at the corners, and pervious material plugs locked into the under channel provides a permeable surface covering with superior structural integrity. The irregular shape also provides a natural, non-geometric appearance to the surface covering.

FIG. 5B is a plan view of an exemplary mold box 140 layout showing units 110 having side cavities 115 and an under channel 136. The under channel is formed by a core puller 142 as shown. The under channel can have any shape.

FIGS. 7 and 8 illustrate a third embodiment of the invention. Multiple units 210 are assembled to form a surface covering 230. As with the first and second embodiment, units 210 have irregularly shaped sides 212, 214, 216 and 218 that provide interlocking, structural integrity to the surface covering. The surface covering includes passageways or gaps 234 between units. Gaps 234 can be formed by providing spacers on the sides of units as described above in reference to the first embodiment, recessing portions of the sides as discussed above in reference to the second embodiment, or merely by varying the side configurations slightly such that adjacent units mate less than perfectly. Units 230 further include side cavities or side channels 215. Gaps 234 function to permit drainage of liquid between units into cavities 215 for below surface retention and/or conveyance. Gaps 234 and cavities 215 can be wholly or partially filled with pervious material or left wholly or partially open. Under side cavities 215 may be aligned in a surface covering for sub-surface water conveyance as described above in reference to the FIG. 4A embodiment.

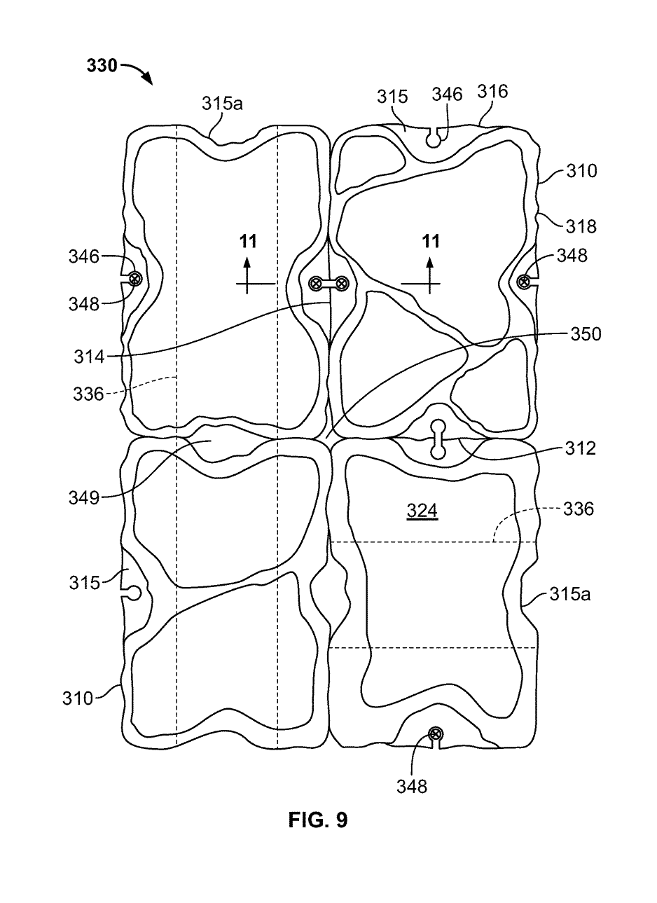

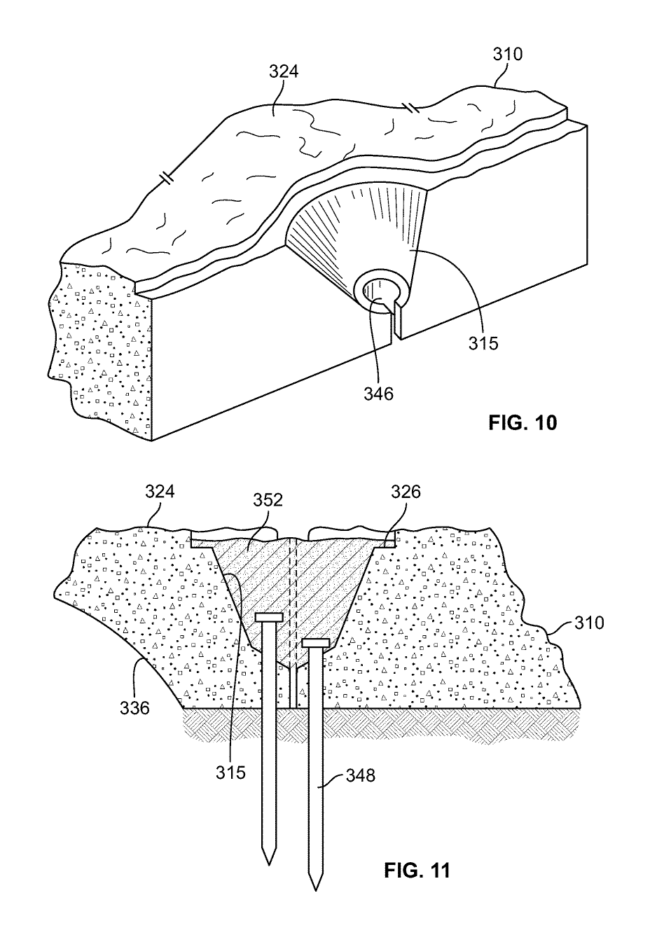

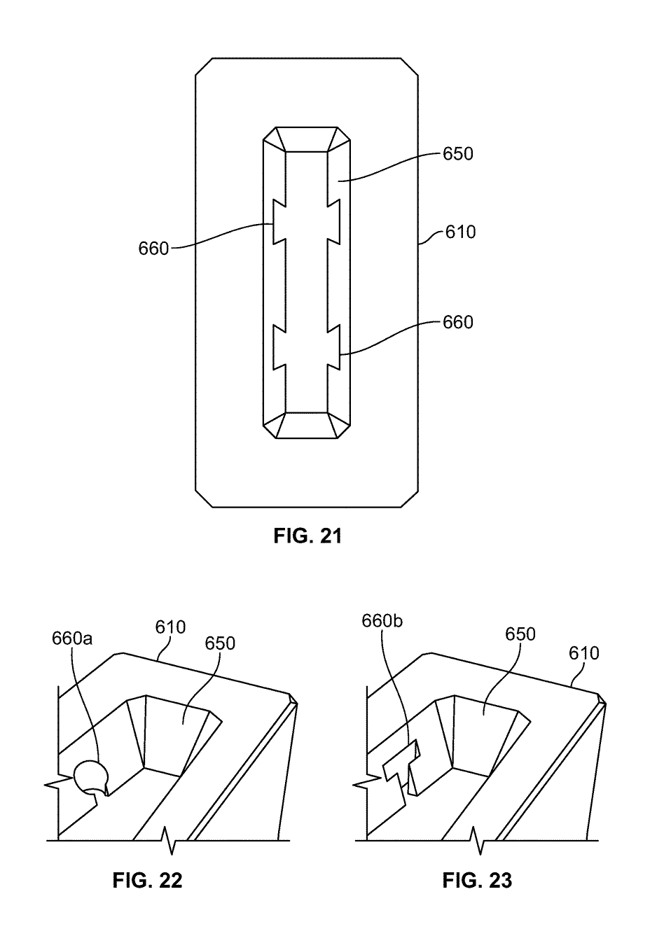

FIGS. 9-11 illustrate a fourth embodiment of the invention. Multiple units 310 are assembled to form a surface covering 330. Units 310 have a regular, rectangular configuration with antiqued, roughened or natural rock-like sides 312, 314, 316 and 318. In other embodiments the sides can be irregularly shaped. Optionally, units 310 have an under channel 336, which if employed can run either longitudinally or transversely of the unit, or can run on the lower sides of the unit as shown in FIG. 8. Optionally, the unit may include one or more stone or cobble elements 324 separated by one or more false joints 326. The cobble elements are preferably irregularly shaped. Similarly, the false joints 326 may vary in number, configuration and width to lend a natural appearance to the surface covering. At least one, preferably plural sides are provided with one or more side cavities 315, at least some of which intersect the under cavity (if provided). The configuration of the side cavities in plan view are preferably irregularly shaped, but geometric shapes are contemplated. A portion of the side cavities 349 can extend vertically downward to intersect the under channel 336. Passageways or cavities 350 can also be formed between the corners of the units. One or preferably plural side cavities 315 are stepped as shown in FIG. 10 and include a locking slot 346. The sides of cavities 315 are preferably sculpted in an irregular configuration. Locking slots 346 can be key-hole shaped as shown. Other locking slot shapes can be used, however, as shown for example in FIGS. 21 and 23. Locking slots of adjacent units optionally align in the surface covering as shown in FIG. 9. On the margins of a surface covering, such as a patio, rods, pins or stakes 348 can be driven through the locking slots to laterally secure the units in position on the ground or foundational base material layer. Thereby, it may be possible to dispense with costly edge restraining devices. Stakes can also be driven in interior areas of the surface covering as may be desired. The stakes can be straight as shown, or may be inverted “J” or “U” shapes to engage and interlock adjacent units. The stakes can be fabricated from plastic, metal or other suitable materials.

The side cavities 315, 349, corner cavities 350 and locking slots 346 can be filled with pervious material that preferably includes a binder, as described above. The shape of the slot facilitates locking in pervious material. The cured pervious plug 352 encapsulates the top portion of the stakes 348 and forms a link between adjacent units to tie the surface structure together and enhance the structural integrity of the surface, as shown in FIG. 11. Inverted “J” or “U” shaped stakes can also be used to mechanically tie adjacent units together.

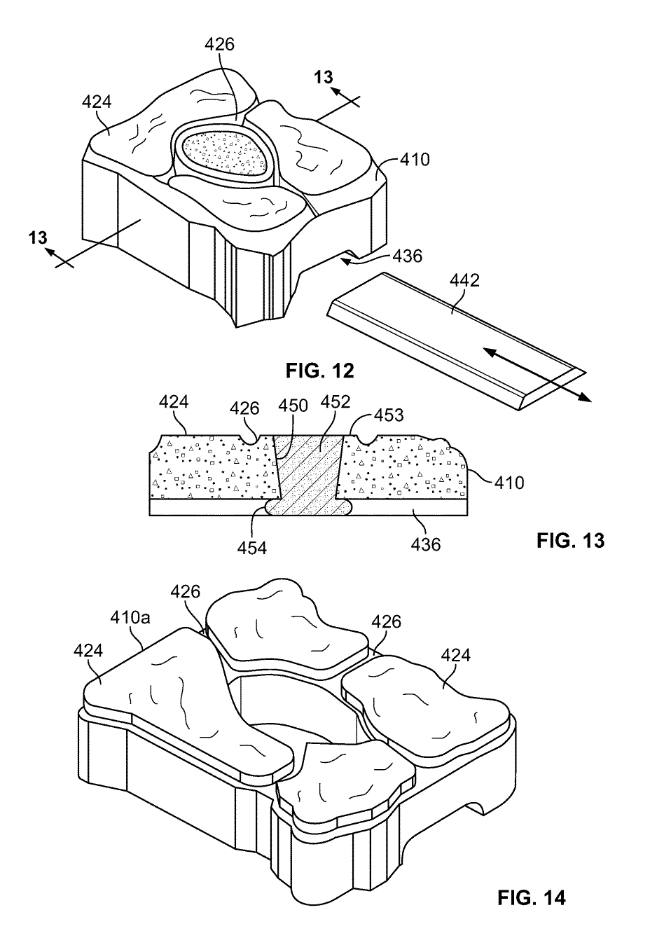

FIGS. 12-16 illustrate a fifth embodiment of unit 410. Referring to FIGS. 12 and 13, unit 410 has the same basic configuration as unit 10 of the first embodiment, including irregularly shaped, sculpted sides; one or more stone, cobble or slab elements 424 separated by false joints 426; and one or more under channels 436. In lieu of an under channel an undercut can be provided as discussed in greater detail relative to the eighth embodiment herein below. As shown, unit 410 does not include spacers, but optionally spacers can be provided. Unit 410 includes at least one core 450 that intersects under channel 436. The core is preferably drafted as shown best in FIG. 13. The area, configuration and location of the cavity can be varied from unit to unit. The area in plan view of the core cavities can be in the range of about 3 to 40 percent of the total area of the unit, more preferably in the range of 5 to 20 percent of the unit area.

The core 450 is filled with pervious material preferably including a binder. The permeability of the core material can be adjusted based on the selection of aggregate, binders and other additives. The pervious material provides a drainage path or passageway from the top of the unit to the under channel or cavity. Pervious material is poured into the core and allowed to slump into the under channel When the resin or other binder cures, a pervious plug 452 is formed. The combination of a drafted core and a plug that includes a portion 454 extending into the under channel, locks the plug into place within the unit like a rivet, i.e., the plug is at least partially converging and diverging in the vertical direction. The shape of the plug resists dislodgement due to mechanical forces such a vehicular traffic or hydraulic forces such as water pressure. The plug may be cast in the unit as a part of the manufacturing process, or more preferably can be poured in situ after the basic units 410 are assembled into a surface covering. As shown in FIG. 13 a rim 453 extends around the top edge of the plug 452. However, the rim can be segmented or removed in part(s) so as to connect the false joints 426 to the pervious plug 452 to promote drainage.

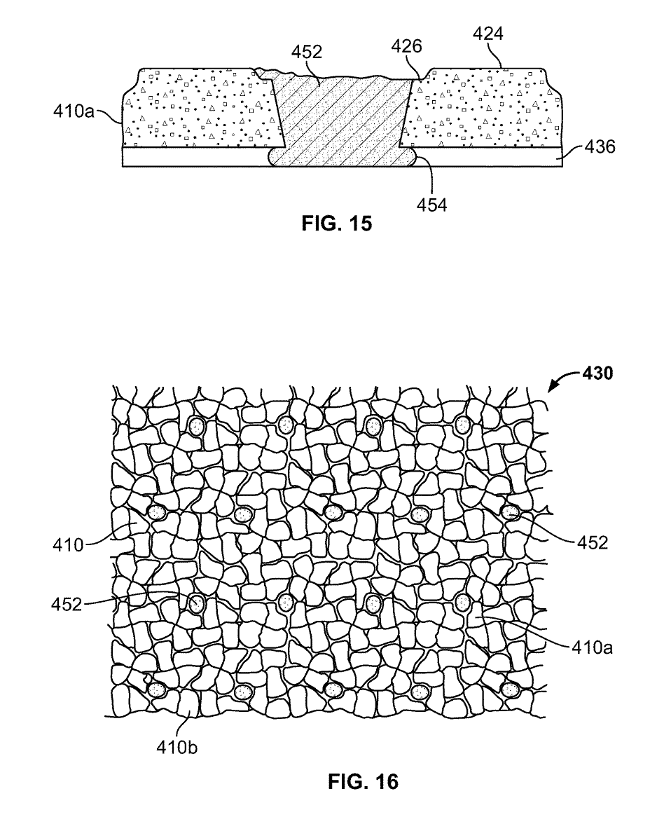

FIGS. 14 and 15 illustrate a unit 410a that is a variation of unit 410 that does not include a rim. Unit 410a has a pervious plug 452 the top surface of which is at substantially the same depth as the bottom of false joints 426. Thereby the false joints can channel liquid such as storm water into the pervious plug and thereby enhance drainage. The pervious material can optionally extend into the false joints.

FIG. 16 illustrates an exemplary surface covering 430 which may be comprised of units 410, or units 410a, or a combination thereof. The surface covering is preferably formed by laying precast, unfilled units on a properly prepared bed. After the units have been laid, pervious material plugs can be poured in situ. Optionally, gaps (not shown) between units can be filled with the same cemented pervious material. Alternatively the gaps between units can be subsequently filled with another pervious material, which may or may not contain a binder. To add to the natural appearance of a surface covering, the location, size and configuration of the cores and plugs can be varied from unit to unit. Further, the surface covering can include units 410b that have the same overall shape and configuration as unit 410, but without a core or pervious plug. As a further option, side cavities can be provided on a plurality of units as discussed above in connection with the second embodiment.

The mix of pervious units 410, 410a and impervious units 410b and resulting absorption rate can be varied per design or randomly mixed. The FIG. 16 embodiment shows a mix of about one pervious unit 410 per 4 impervious units, resulting in a surface that is approximately 4% pervious material. The conditions of a particular site may call for greater drainage in some areas and less in others. In the landscape system of the fifth embodiment the ratio of pervious units to impervious units may be adjusted accordingly. Further, units with larger pervious plugs may be selected for areas calling for enhanced drainage. In this way, the ratio of the pervious area to total surface area may be adjusted within a range of about 3% to about 50%.

FIGS. 17A and 17B illustrate a sixth embodiment of unit 510. Unit 510 has the same basic configuration as unit 10 of the first embodiment, including irregularly shaped, sculpted sides; one or more stone, cobble or slab elements 524 separated by false joints 526; and an optional under channel or cavity 536. Unit 510 optionally can include spacers (not shown in FIG. 17A). Unit 510 includes a conventional substantially impervious portion 556 and a pervious portion 558. The impervious portion 556 can be made of concrete. The pervious portion 558 is comprised of a mixture of an aggregate and binder, such as a polymeric resin. The pervious and impervious portions can be manufactured together, such as by co-molding. Alternatively they may be separately molded. For example, the pervious portion may be first molded and cured, and then inserted into the mold for unit 510 wherein the impervious material is placed and molded. The pervious piece can be co-molded with the substantially impervious unit. Alternatively, the pervious piece can be formed separately from the main unit for assembly either before or after the main units are laid to form a surface covering. Finally, the pervious portion can be poured in situ. In a preferred embodiment, pervious portion 558 at least partially intersects with cavity 536.

Turning now to FIG. 17B, a surface covering 530 comprises a combination of pervious units 510 and impervious units 510b. Impervious units 510b have the same configuration as units 510 but lack a pervious portion 558. As with the surface covering 430 of the FIG. 16 embodiment, fewer or greater numbers of pervious units relative to imperious units may be provided depending on the localized drainage requirements. The FIG. 17B embodiment, for example, shows a mix of about one pervious unit 510 per 3 impervious units 510b that results in a surface that is approximately 6% pervious. As with the FIG. 16 embodiment, the ratio of the pervious area to total surface area may be adjusted within a range of about 3% to about 50%.

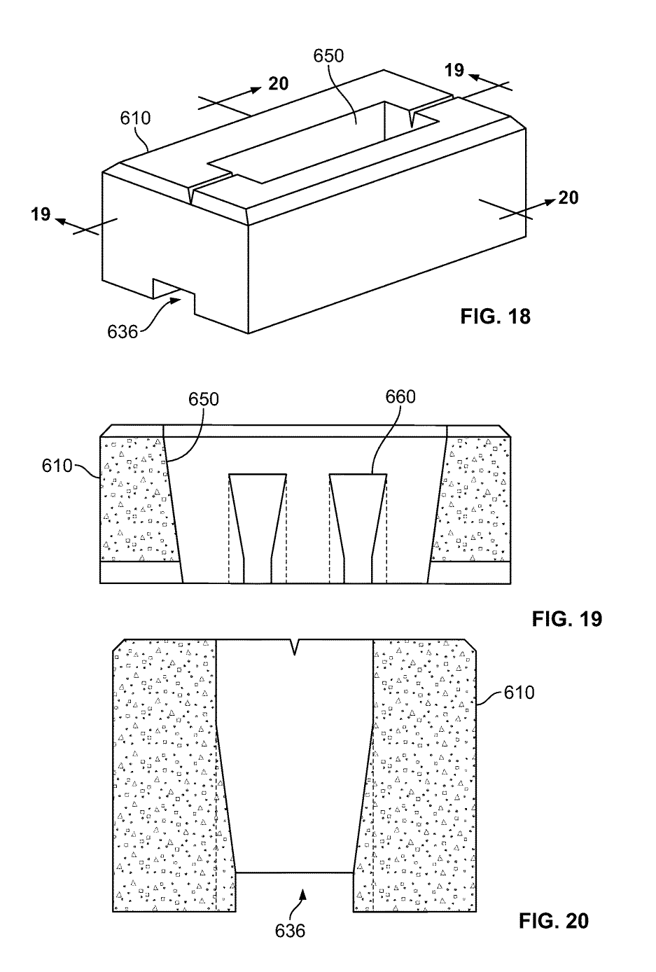

FIGS. 18-23 show a seventh embodiment of the unit 610 of the invention. The outer configuration of unit 610 is a basic rectangular shaped paver, which is well known in the art. Other unit configurations, including irregular configurations are contemplated. Unit 610 includes a core cavity 650 and optional bottom channel 636 and that intersects the core cavity. The core cavity is preferably drafted, i.e., tapering from top to bottom as shown in FIGS. 19-21. However, one or more sides can be substantially vertical. The core cavity includes at least one, preferable plural slots 660 that form locking points positioned on the inner walls of core cavity 650.

The core cavity 650 is configured and adapted to be filled with a pervious material including a binder to form a pervious plug (not shown) as discussed above relative to the fifth embodiment. If an under channel 636 is provided, the pervious material poured into the core cavity is allowed to slump into the under channel 636 thereby locking the plug into the core. Pervious material will also extend into slots 660 to provide enhanced structural connection between the plug and unit. If the optional under channel is not provided, the locking slots function to resist dislodgement of the plug due to mechanical forces, such as torque and traffic loads, and hydraulic forces. Different shaped slots may be used, including but not limited to a dovetail slot 660 as shown in FIGS. 19-21. Alternate slot shapes can be used, including but not limited to a key-hole slot 660a as shown in FIG. 22 and a T-shaped slot 660b as shown in FIG. 23. Locking slots can also be optionally provided on the exterior of the unit to enhance the structural connection between units as described above in reference to the fourth embodiment.

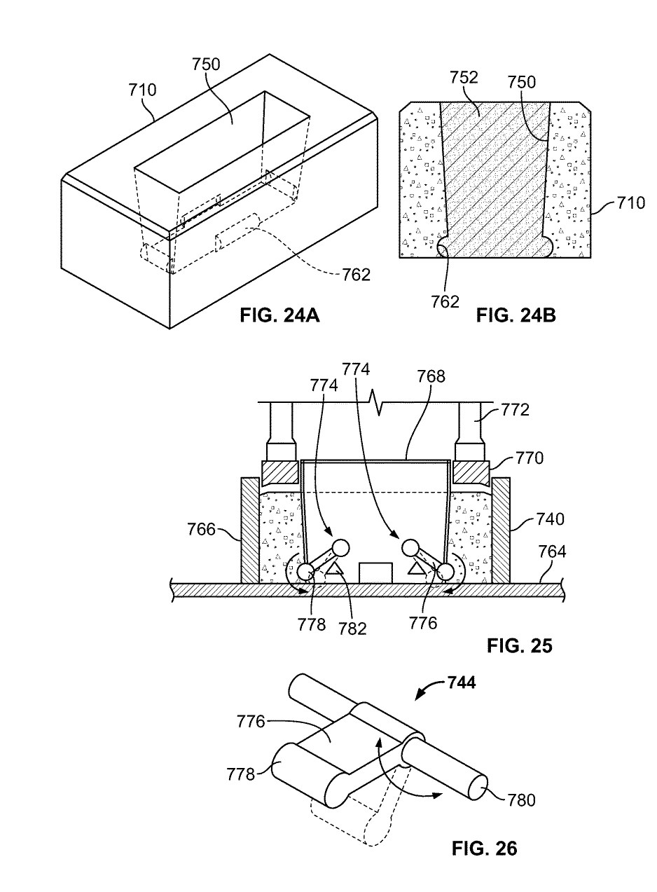

FIG. 24 illustrates an eighth embodiment of a unit 710. Unit 710 is shown as having a rectangular exterior configuration similar to the seventh embodiment. However, other configurations can be used including, but not limited to the configurations shown and described above relative to embodiments one through six. Unit 710 includes a core cavity 750 extending vertically though the unit. The core is preferably drafted. The cavity is illustrated as having a rectangular shape in plan view but other shapes can be used. The core cavity is configured to be filled with a pervious material including a binder to form a pervious plug 752. Unit 710 may optionally include an under channel or cavity as shown and described above in reference to embodiment seven (not shown in FIG. 24A and 24B).

Cavity 750 further includes one or more undercuts 762. Undercut 762 is a recess, cavity or depression in the side of the core. Undercuts may be located at the lower end of the unit, as shown in FIG. 24B for example, or may be located in the midrange of the core. The undercuts and drafting of the cavity combine to create an interior cavity volume that is at least partially converging and diverging in the vertical direction. Accordingly, when the cavity is filled with pervious material mixture of an aggregate and binder, and the binder sets, the resulting pervious plug is locked into the cavity. The plug resists dislodgement from mechanical and/or hydraulic forces. The undercut can be of any desired shape or size, including but not limited to the semi-cylindrical shape shown. Other shapes can be used, including rectangular and triangular shapes. Undercuts can also be made in one or more locations of the exterior side walls (not shown).

A common method of manufacturing concrete units such as unit 710 is the dry cast method. However, it is not possible with conventional technology to economically mold undercuts, especially undercuts in interior cavities. In most molding operations cavities are preferably drafted, progressively tapering in one direction only so that at a core can be easily pulled. To meet this challenge, a molding apparatus and method are provided for economically molding undercuts in dry cast concrete units, such as but not limited to unit 710. FIG. 25 is a partial section of a mold box 740 positioned on pallet 764. The box 740 comprises division walls 766, core 768 for forming the cavity, tamping shoes 770, plungers 772 and pendulum devices 774 for forming undercuts. Pendulum device 774 comprises a pendulum member 776 have a molding end 778 that is pivotally mounted to a shaft 780, and a stop 782. The end of the pendulum and correspondingly molded undercuts are shown as being cylindrical, but other shapes are contemplated, including rectangular bar shapes and triangular shapes.

The molding device operates as follows. Initially, mold box 740 is positioned on pallet 764, which causes pendulum members 776 to rotate upwardly and outwardly to the position shown in solid lines in FIG. 25. The core 768 is positioned in the mold box above the molding ends 778 of the pendulum members. An appropriate volume of concrete is placed into the mold and tamped with shoes 770 to form a unit 710. The mold is then opened by separating the pallet 764 vertically relative to the mold box. The shoes 770 coupled to mechanical means and with the assistance of gravity press unit 710 out of the mold, the unit remaining on the pallet. Gravity plus the force caused by the relative movement of the unit to the mold box causes the pendulum members 776 to swing downwardly and inwardly to the position shown in dashed lines in FIGS. 25 and 26. Added mechanical assistance, e.g., springs, can be provided to facilitate retraction of the pendulum members. Simultaneously, as the pendulums retract, the unit is removed from the mold box. The newly cast unit 710 can then be moved to another location to cure. Undercuts can be formed with alternative devices and methods, the mold box shown and described in FIGS. 25 and 26 being one example.

While particular embodiments of the present invention have been described herein, it will be appreciated by those skilled in the art that changes and modifications may be made thereto without departing from the invention in its broader aspects. In particular the specific features of one embodiment may be combined with features of other embodiments. Non limiting examples of such combinations have been provided herein above. Other combinations will be apparent to those skilled in the art and are contemplated herein.

1. A permeable surface covering unit comprising
a top surface, a bottom surface and at least two pairs of sides,
at least one cavity in the unit extending from the top surface to the bottom surface and having side walls,
at least one undercut formed in at least one of the side walls of the cavity, and
a pervious material plug at least partially filling the cavity and lower portion of the plug extending into the undercut.

2. A permeable surface covering unit as in claim 1, wherein the undercut comprises at least two undercuts on opposite side walls of the core cavity adjacent the bottom surface of the unit.

3. A permeable surface covering unit as in claim 1, wherein the undercut comprises a bottom channel, the core cavity intersecting the bottom channel and the pervious material plug at least partially extending into the bottom channel.

4. A permeable surface covering unit as in claim 1, wherein the top surface of the unit comprises stone shaped elements separated by false joints.

5. A permeable surface covering unit as in claim 4 wherein the false joints are in communication with the pervious material plug.

6. A permeable surface covering unit as in claim 1 wherein the cavity is formed into at least one side of the two pairs of sides of the unit.

7. A permeable surface covering unit as in claim 6 wherein the plan view of the cavity is in the range of 3 to 15 percent of the total area of the unit.

8. A permeable surface covering unit as in claim 1 further comprising a spacer on at least one side of the pair of sides of the unit.

9. A permeable surface covering unit as in claim 1 wherein the two pairs of sides substantially form a rectangle.

10. A permeable surface covering unit comprising:
a top surface, a bottom surface and at least two pairs of sides,
at least one cavity in the unit extending from the top surface to the bottom surface and having side walls, the cavity tapering from a larger to smaller surface area in the direction from the top surface to the bottom surface,
at least one undercut formed in at least one of the side walls of the cavity, and
a pervious material plug at least partially filling the cavity and lower portion of the plug extending into the undercut.

11. A permeable surface covering unit of claim 10 wherein at least one of the side walls of the cavity is substantially vertical.

12. A permeable surface covering unit of claim 10 wherein the at least one undercut is a semi-cylindrical shape.

13. A permeable surface covering unit of claim 10 wherein the at least one undercut is a rectangular shape.

14. A permeable surface covering unit of claim 10 wherein the at least one undercut is a triangular shape.

15. A permeable surface covering unit of claim 10 wherein the top surface of the unit comprises false joints.

16. A permeable surface covering unit as in claim 10 wherein the cavity is formed into at least one side of the two pairs of sides of the unit.

17. A permeable surface covering unit as in claim 10 wherein the cavity is formed within the unit.

18. A permeable surface covering unit as in claim 10 wherein the two pairs of sides substantially form a rectangle.

19. A permeable surface covering unit comprising:
a top surface, a bottom surface and a first pair of irregularly shaped mating sides and a second pair of irregularly shaped mating sides, wherein each of the sides of the first pair of sides have substantially the same configuration, and each of the sides of the second pair of sides have substantially the same configuration, and wherein each of the sides of the first pair of sides is rotationally spaced from one another by a first angle, and each of the sides of the second pair of sides is rotationally spaced from one another by a second angle.
at least one cavity in the unit extending from the top surface to the bottom surface and having side walls,
at least one undercut formed in at least one of the side walls of the cavity, and
a pervious material plug at least partially filling the cavity and lower portion of the plug extending into the undercut.

20. A permeable surface covering unit as in claim 19 wherein the cavity is formed into at least one side of the unit.
